(19) United States
(12) Patent Application Publication
(10) Pub. No.: US 2012/0107634 A1
(43) Pub. Date: May 3, 2012

(54) Skull mounting apparatus

(75) Inventor: Lance D. Swarthout, Roaring Branch, PA (US)

(73) Assignee: SWARTHOUT WILDLIFE MOUNTING SYSTEMS, LLC

(21) Appl. No.: 12/925,928

(22) Filed: Nov. 1, 2010

(51) Int. Cl. B32B 3/10; B32B 3/00; B32B 15/01

(52) U.S. Cl. 428/596; 428/615; 428/603

(57) ABSTRACT

A display apparatus for an animal skull includes a base plate sized to receive the skull of an animal and a wall display plate. The wall display plate is attached to the base plate at a mounting angle of between 120° and 150 °. The wall display plate is adapted to be mounted to and to lie flat against a vertical wall with the base plate sloping downwardly with a nose portion being at a lowest location and a neck portion being at a highest location on the base plate. The wall display plate displays a silhouetted scene including an animal of a same type as the animal skull to be mounted on said mounting display.

### BACKGROUND OF THE INVENTION

1. Field of the Invention

The present invention relates to a skull mounting apparatus. More specifically, it relates to a skull mounting apparatus having a wall display plate displaying a silhouetted scene including a game animal of a same type of the animal skull to be mounted on said mounting display.

2. Description of the Prior Art

Many men, women and children enjoy the sport of hunting. Many hunters (and some non-hunters) also enjoy displaying the antlers, heads, skulls or other parts or the entirety of game animals as a trophy. Such displays often appear in homes, hunting camps, lodges and can add a rustic ambiance, a western theme or even a somewhat magical or mysterious feel to the room. Many who wish to decorate with such animal parts utilize the services of taxidermists. Taxidermist can do amazing work to make the animal or animal part look surprisingly lifelike. The cost of such taxidermy work, however, can be quite expensive and involves much labor.

As an alternative to making a lifelike trophy with the aid of a taxidermist, others prefer to clean the skull and to mount only the skull or the skull with attached antlers. Although there are many ways of cleaning the skull of an animal. One such process of cleaning an animal skull is very fascinating and cleaning is accomplished, in part, by insect removal. This process utilizes the dermist beetle to eat and thereby remove all tissues and skin from the head of the animal. Thereafter, the skull is degreased and whitened by both chemical bath and light exposure processes.

A variety of mounting arrangements and shelves and the like have been proposed in the past. A “Trophy Mount” is disclosed in Dotzman, U.S. Pat. No. 4,464,440 wherein horns 12 of an animal can be mounted onto a “simulated” skull structure 14. The skull structure 14 is supported by a display support 18 which includes a flattened, rectangularly shaped plate 42 and an extension brace 48. A somewhat similar device is disclosed in Green, U.S. Pat. No. 5,472,765 which provides a “Shed Antler Mounting Kit” which mounts the horns of an animal to a simulated animal skull or skull replica 12. The skull replica 12 is mounted on a plaquelike base 16 with a mounting wedge 14. The skull replica is said to impart a degree of realism and ornament to the display.

Goettl, U.S. Pat. No. 6,828,035 discloses a “Wall Pedestal for Displaying Animal Heads and Other Wildlife Objects” which includes a pedestal 10 having an imitation mounting plate cover 12 (generally rectangular in shape) and an imitation support arm 14 to simulate a weathered wood or rock. The wildlife object can be rotated to various positions for viewing.

Damin, U.S. Patent Application Pub. No. U.S. 2009/0230250 discloses a “Convertible Taxidermy Mounting System” which can be adapted to mount a skull and horns either on a vertical wall (see configuration of FIG. 10) or on a horizontal surface (see configuration of FIG. 9).

An image for a commercially available product from a Cabela online catalog which is located at:

http://images.cabelas.com/is/image/cabelas/s7_{—}226094_imageset_{—}02?$main-Large$ discloses a skull mounting apparatus which has a circular wooden wall plate which is substantially hidden behind a wooden base plate and which appears to have a shape which is superficially similar to the base plate of the present invention in that a body width appears larger than a nose width and a neck width. However, the neck of this device is not attached to the wall plate and the wall plate is hidden below the upper surface of the base plate.

An image of another commercially available product of similar design is located at: http://www.toysbytemplin.com/ToysEuro%20Skull%20Mount%202.JPG wherein a circular wooden wall plate is mounted to a wooden base which has a wide neck portion which is not attached to the wall plate.

An image of yet another commercially sold under the name “Animals in Motion” is located at: http://www.jimallred.com/animalsinmotion.aspx

This product shows a device having a wall plate which appears to show a metal plate showing a scene including trees and animals. A large bracket or swing arm is used to space a mounting plate (which may be hidden inside the animal) away from the wall. The mounting plate is then mounted to the animal head or to a wooded base plate onto which the animal head is mounted.

There remains a need and it is an object of the present invention to provide a skull mounting apparatus which holds the skull in an aesthetically pleasing angle.

It is also an object of the present invention to provide a skull mounting apparatus which is simple to manufacture and which can be fabricated at a low cost.

It is also an object of the present invention to provide a skull mounting apparatus which includes an artistic silhouetted scene which displays the type of animal which the apparatus will hold.

### SUMMARY OF THE INVENTION

As alluded to above, to date there has not been proposed a mounting apparatus which is specifically designed and created to elegantly display an animal skull in an artistically and aesthetically pleasing manner. One of the features which makes the present invention unique is the provision of a base plate which has a narrow neck portion, wide body portion and a narrow nose portion dimensioned for the particular animal skull in mind so that when the skull is displayed there will be a black border surrounding the perimeter of the skull to frame the skull on the base plate. The contrast of the white skull with a generally even black border surrounding the same provides a striking view.

Additionally, because the base plate is preferably attached to a wall display plate at a mounting angle of approximately 135°, the base plate slopes outwardly and downwardly away from the wall and places the animal skull in a natural position as the animal would hold its head while in a standing position. This mounting angle provides a far more natural looking view of the skull and allows it to be easily seen.

Yet another feature of the present invention is the provision of a wall display plate which includes a silhouetted scene displaying a game animal of a same type of the animal skull to be mounted on said mounting display. While most hunters will readily be able to identify the type of animal from the skull alone, many friends, relatives or members of the general public who view the mounted skull might not be able to identify the animal type just from the skull alone. Including a game animal in the silhouetted scene allows such persons to readily identify the animal type and also provides an additional artistic and aesthetic element to the display.

This present invention is presently designed for five (5) different “types” or families of animals. These types include: (1) Carvidae (deer) which includes but is not limited to Mule Deer, Whitetail Deer and Blacktail Deer; (2) Ursidaw (bear) which includes but is not limited to Grizzly Bear, Brown Bear, Black Bear and Polar Bear; (3) Canidae (canine) which includes but is not limited to Fox, Wolf and Coyote; (4) Felidae (cat) which includes but is not limited to Lynx, Bobcat and Cougar aka Mountain Lion; and (5) Suidae (swine) which includes but is not limited to Wild Boar aka Wild Pigs, Bearded Pig and Warty Pig. It will be obvious to one of ordinary skill in the art that an additional skull display apparatus can be easily made for the skull of each other type of animal not described above which one might wish to mount. For example, a display apparatus according the present invention for any of the following North American big game animals (or many other animals worldwide) could also be easily created: American Alligator; Pronghorn Antelope; Barren Ground Grizzly Bear; American Black Bear; Alaska Brown Bear; Common Grizzly Bear; Polar Bear; American Bison; Barren Ground Muskox; Greenland Muskox; Artic Islands Caribou; Alaska Yukon Barren Ground Caribou; Central Canada Barren Ground Caribou; Mountain Caribou; Quebec Labrador Caribou; Woodland Caribou; Bobcat; Canada Lynx; Jaguar; Mountain Lion; Central American Whitetail Deer; Columbia Blacktail Deer; Coues Whitetail Deer; Desert Mule Deer; Gray Brown Brocket Deer; Mexican Whitetail Deer; Northeastern Whitetail Deer; Northwestern Whitetail Deer; Red Brocket Deer; Rocky Mountain Mule Deer; Sitka Blacktail Deer; Southeastern Whitetail Deer; Texas Whitetail Deer; Rocky Mountain Elk; Roosevelt Elk; Tule Elk; American Mountain Goat; Alaska Yukon Moose; Eastern Canada Moose; Shiras Moose; Western Canada Moose; Collared Peccary or Javelina; White Lipped Peccary; California Bighorn Sheep; Dall Sheep; Desert Bighorn Sheep; Rocky Mountain Bighorn Sheep; Stone Sheep; Atlantic Walrus; Pacific Walrus; Gray Wolf; and Wolverine. With each animal “type” the relative dimensions of the neck width, body width and nose width of the base plate will vary so that the skull of each animal type will have a generally uniform border which extends beyond the perimeter of the actual skull.

For example, when the said animal skull is a coyote skull (canine type), the neck width is less than said nose width. When the animal skull is a bear skull, the neck width is greater than said nose width. When the animal skull is a deer skull, the neck width is greater than said nose width. When the animal is a cat type skull the neck width is less than said nose width. Finally, when the animal is a swine type skull, the neck width is less than the nose width. Still further, it is contemplated that two or more different sizes of displays (large and small for example) may be created for each animal type to accommodate the size differential of various individual animal skulls or to accommodate the wall space requirements or limitations of individual users.

Additionally, the wall display plate will vary with each animal type and each such wall display plate will include a graphical representation or display of such animal type. A variety of different wall display plates can be created for any particular animal or animal type so that the end user can select a particular scene that he/she finds most aesthetically pleasing.

In its simplest form, the display apparatus for an animal skull of the present invention includes: a) a base plate sized to receive the skull of a big game animal, said base plate including a neck portion, a body portion and a nose portion; and b) a wall display plate, said wall display plate being attached to said base plate at a mounting angle of between 120° and 150°, said wall display plate adapted to be mounted to and to lie flat against a vertical wall whereby when said wall display plate is mounted to a vertical wall said base plate slopes downwardly with said nose portion being at a lowest location and said neck portion being at a highest location on said base plate, said wall display plate displaying a silhouetted scene including an animal of a same type as the animal skull to be mounted on said display apparatus.

Preferably, said base plate has a vertical cut out slot therein to receive a skull mounting bolt at any location along the vertical slot to allow for vertical adjustment of the skull on the base plate.

Preferably, a plurality of horizontal slots are cut into said sheet of metal at the location of said bend.

Preferably, said mounting angle is between 130° and 140° and the presently preferred mounting angle is approximately 135°.

Preferably, said base plate and said wall display plate are made from a single sheet of metal with a bend at said mounting angle. Said metal preferably has a thickness in the range of approximately 1/32 inch to ⅛ inch.

Preferably, said base plate and said wall display plate are completely black in color.

Said base plate preferably has a neck portion, a body portion and a nose portion, with said neck portion having a narrow neck width and being attached to said wall display plate, said body portion having a wide body width and said nose portion having a narrow nose width. Preferably, when said neck width is added to said nose width, a total width of the neck and nose is approximately equal to said body width.

### BRIEF DESCRIPTION OF THE FIGURES

FIG. 1 is a front view of the skull mounting apparatus of the present invention.

FIG. 2 is a top view of the skull mounting apparatus of FIG. 1.

FIG. 3 is a left side view of the skull mounting apparatus of FIG. 1.

FIG. 4 is a perspective view of the skull mounting apparatus of FIG. 1.

FIG. 5 is a perspective view of the skull mounting apparatus of FIG. 1 also showing a bear skull mounted to the apparatus.

FIG. 6 is a perspective view of a skull mounting apparatus showing a coyote head and having a hook for holding a coyote skin.

FIG. 7 is a front silhouette view of a skull mounting apparatus showing two antelope standing on a plain.

FIG. 8 is a front silhouette view of two standing antelope and one lying down.

FIG. 9 is a front silhouette view of a skull mounting apparatus showing a cougar on a rock and a tree.

FIG. 10 is a front silhouette view of a skull mounting apparatus showing a cougar standing on a rock.

FIG. 11 is a front silhouette view of a skull mounting apparatus showing a ram standing on a rock between trees.

FIG. 12 is a front silhouette view of a skull mounting apparatus showing two rams standing between trees.

FIG. 13 is a front silhouette view of a skull mounting apparatus showing a bear walking on rocks between trees.

FIG. 14 is a front silhouette view of an alternate skull mounting apparatus showing a bear walking on grass between trees.

FIG. 15 is a front silhouette view of an alternate skull mounting apparatus showing two bears fighting.

FIG. 16 is a front silhouette view of an alternate skull mounting apparatus showing a bear standing on a rock between trees.

FIG. 17 is a front silhouette view of an alternate skull mounting apparatus showing a bear walking on flat ground between trees.

FIG. 18 is a front silhouette view of a skull mounting apparatus showing a buck standing and a doe lying between trees.

FIG. 19 is a front silhouette view of a skull mounting apparatus showing a buck jumping over a fence between trees.

FIG. 20 is a front silhouette view of an alternate skull mounting apparatus showing a buck jumping over a fence between trees.

FIG. 21 is a front silhouette view of a skull mounting apparatus showing a buck and a doe standing between trees.

FIG. 22 is a front silhouette view of yet another skull mounting apparatus showing a buck standing between trees.

FIG. 23 is a front silhouette view of yet another skull mounting apparatus showing a buck standing between two trees.

FIG. 24 is a front silhouette view of is a front silhouette view of a skull mounting apparatus showing a canine Wolf between trees.

FIG. 25 is a front silhouette view of a skull mounting apparatus showing a canine Wolf head.

FIG. 26 is a front silhouette view of an alternate skull mounting apparatus showing a canine Wolf running between trees.

FIG. 27 is a front silhouette view of a skull mounting apparatus showing a bobcat climbing up a rock between two trees.

FIG. 28 is a front silhouette view of a skull mounting apparatus showing a bobcat descending down a rock between two trees.

FIG. 29 is a front silhouette view of a skull mounting apparatus showing a wild boar running between two trees.

FIG. 30 is a front silhouette view of a skull mounting apparatus showing a wild boar standing between trees.

FIG. 31 is a front silhouette view of a skull mounting apparatus showing a wild boar trotting away from the tree.

### DETAILED DESCRIPTION OF THE PREFERRED EMBODIMENTS

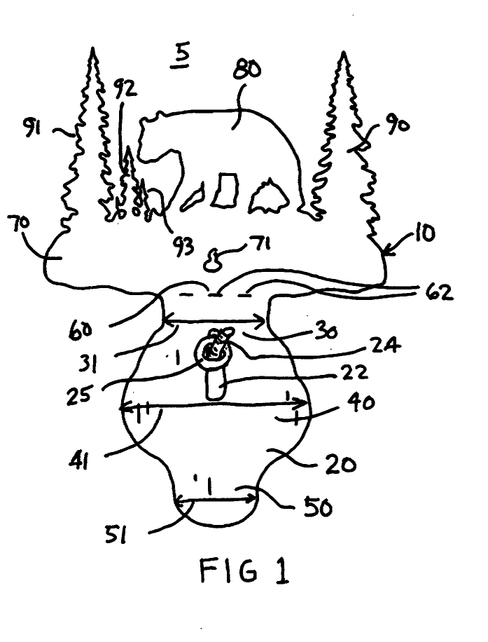

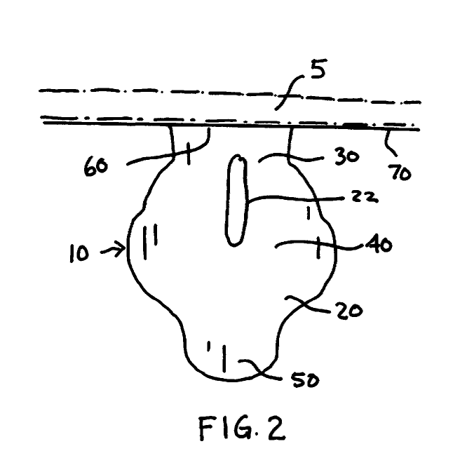

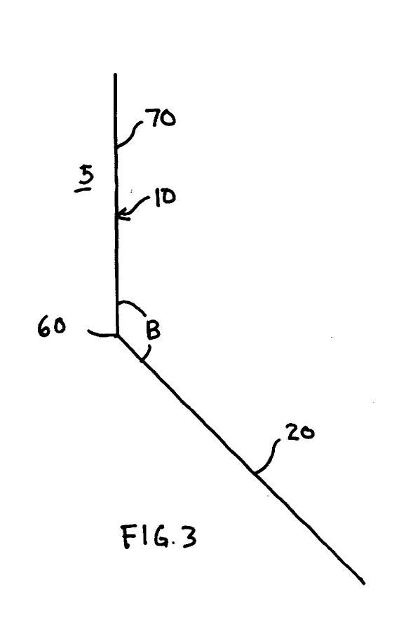

Referring now to FIGS. 1 through 5, one of the presently preferred embodiments of the present invention will be described in detail. The display apparatus 10 includes a base plate 20. The base plate 20 has a neck portion 30 a body portion 40 and a nose portion 50. The neck portion 30 has a neck width 31. The body portion 40 has a body width 41. And the nose portion 50 has a nose width 51. The base plate 20 has a vertical cut out slot 22 therein which allows for the insertion of a bolt or screw 24 utilized to mount a skull 100 to the base plate 20. This vertical slot 22 allows mounting of the animal skull at any vertical location along the slot 22. The ability to make this vertical skull adjustment ensure that the skull has just the right aesthetic look which the user may desire. Also, because the vertical slot 22 is cut somewhat wider than the screw portion of the toggle skull mounting bolt 24 some left right adjustment of the skull on the base plate is also possible. A fender washer 25 is used to help hold the toggle bolt in place. The base plate 20 is a attached to a wall display plate 70 at a bend 60 which is formed at an angle B (see FIG. 3). Preferably, at the location of bend 60, a plurality of horizontal slots 62 are provided which allow for the bend 60 to be easily formed. The display apparatus 10 also includes a wall display plate 70 which is adapted to be mounted adjacent a vertical wall 5 with a nail, screw or other connector (not shown) used in combination with a key hole 71 provided in a lower central portion of said wall plate 70. The wall display plate 70 includes a silhouetted scene which in this particular case includes a bear 80 and various pine trees 90, 91, 92 and 93. In all cases, the silhouetted scene includes an animal of the same type as the animal skull which is to be mounted on the mounting display.

The display apparatus 10 is preferably formed from a single sheet of metal with the bend 60 formed at the mounting angle B which is between 120° and 150°. Preferably, angle B is between 130° and 140° with the preferred mounting angle being approximately 135°. The sheet metal preferably has a thickness of approximately 1/32 inch to ⅛ inch. The entire display apparatus 10 is either painted or otherwise treated or processed to make it completely black in color.

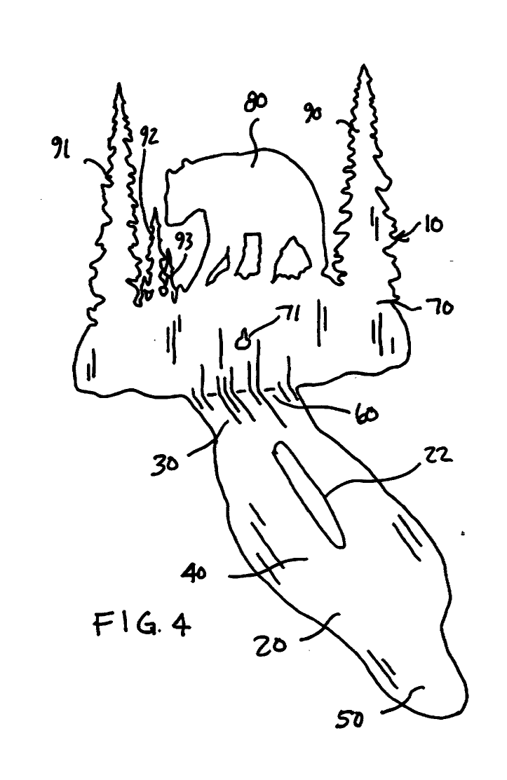

As best shown in FIG. 4, the nose portion 50 is at a lowest location and the neck portion 60 is at a highest location on the base plate 20. As seen in FIG. 1, when a bear skull is to be mounted, the neck width 31 is wider than the nose width 51. In this case, if the neck width 31 and the nose width 51 are added together the total neck-plus-nose width is approximately equal to the body width 41.

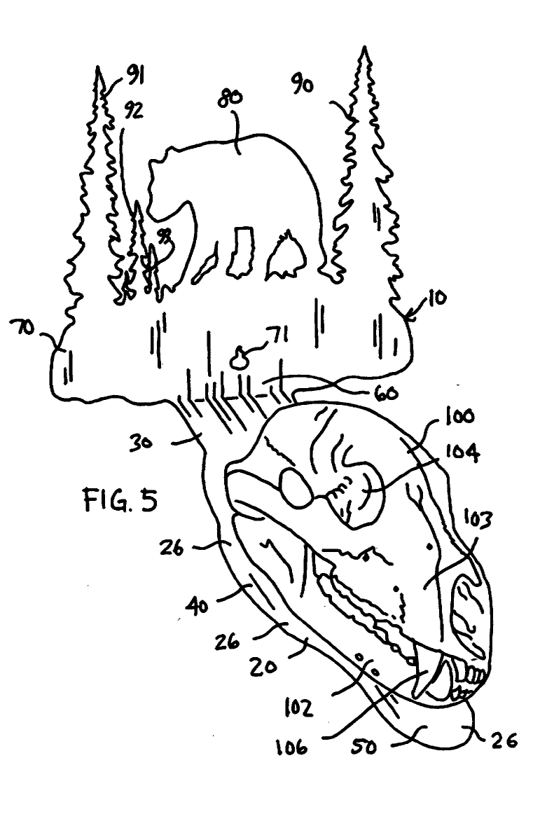

FIG. 5 shows the display apparatus 10 having a bear skull 100 mounted thereto. The bear skull 100 includes an upper jaw portion 103, a lower jaw portion 102, bear teeth 106 and an eye socket 104. As shown, a border 26 of base plate 20 extends outwardly around the outermost perimeter of the bear skull 100. The contrast of the bleached white bear skull adjacent to the black base plate 20 creates a striking and aesthetically pleasing visual display. For anyone who cannot instantly identify skull 100 as being a bear skull, the inclusion of bear 80 in the wall display plate 70 provides an instant clue making such an identification much easier.

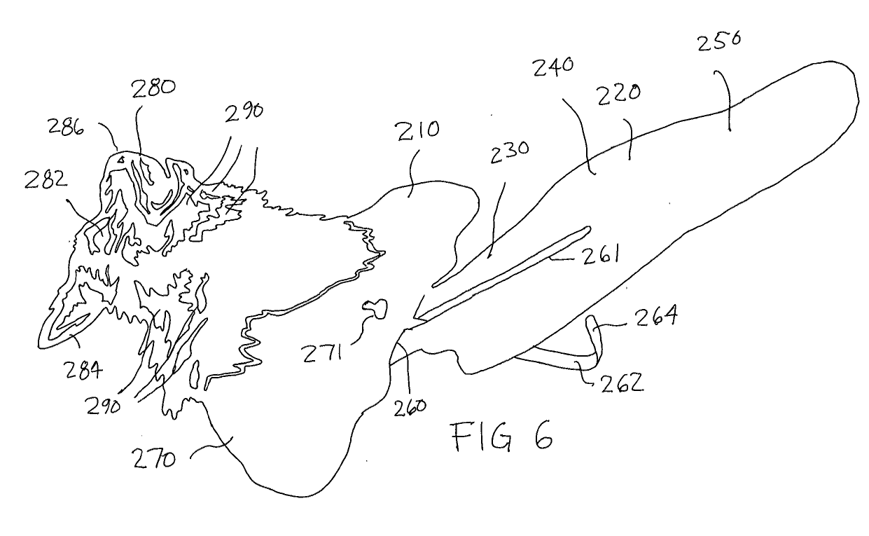

FIG. 6 provides an example of a display apparatus 210 specifically designed for use with the canine type of animal skulls. With this particular type of animal, hunters and sportsmen sometimes also like to display the animal skin and fur in addition to the actual skull. In this case, an elongated strip 260 is cut from the base plate 220 and is bent downwardly as shown at 262. The end of the metal tongue 262 which is created from the material cut at 261 and end portion 264 is bent upwardly to create a hook on which the animal skin can be hung. The base plate 220 has a neck portion 230 a body portion 240 and a nose portion 250. The neck portion 230 is attached to the wall display plate 270 at bend 260. The wall display plate is cut into the shape of a coyote head 280 with various details being provided by the provision of a plurality of different holes 290 cut into wall display plate 270. The combination of these holes 290 create or enhance features of the coyote head 280 such as an ear 284 an eye 282 and a nose 286.

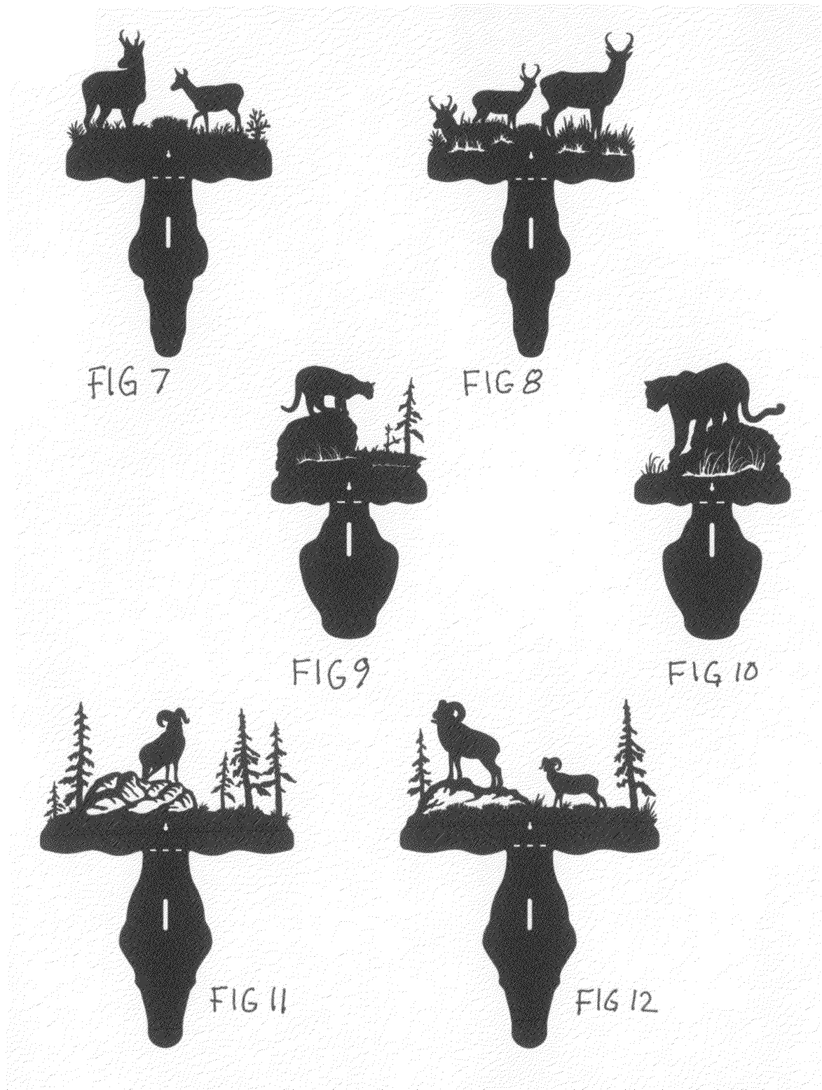

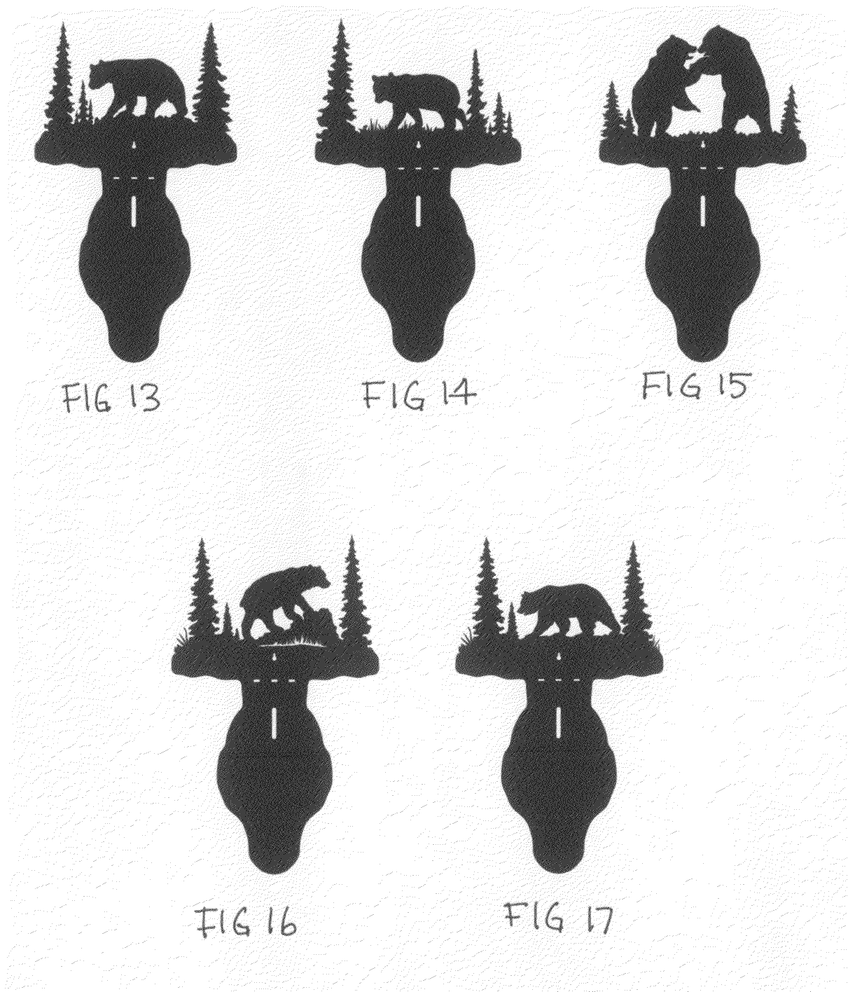

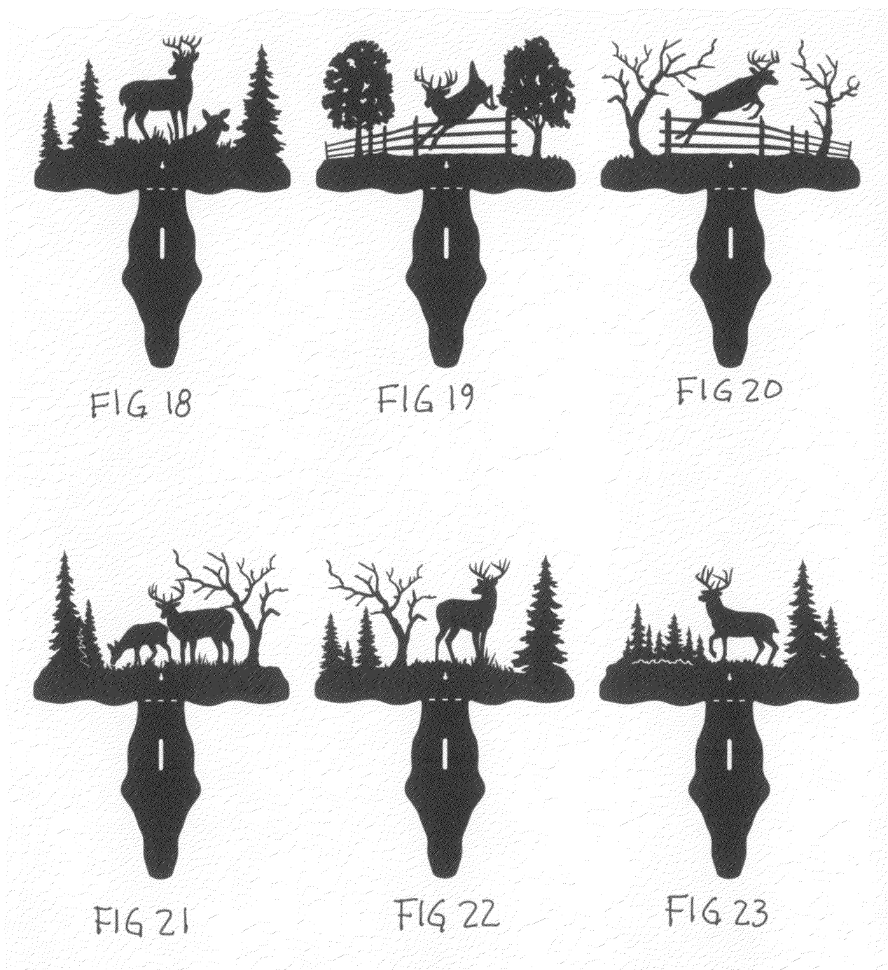

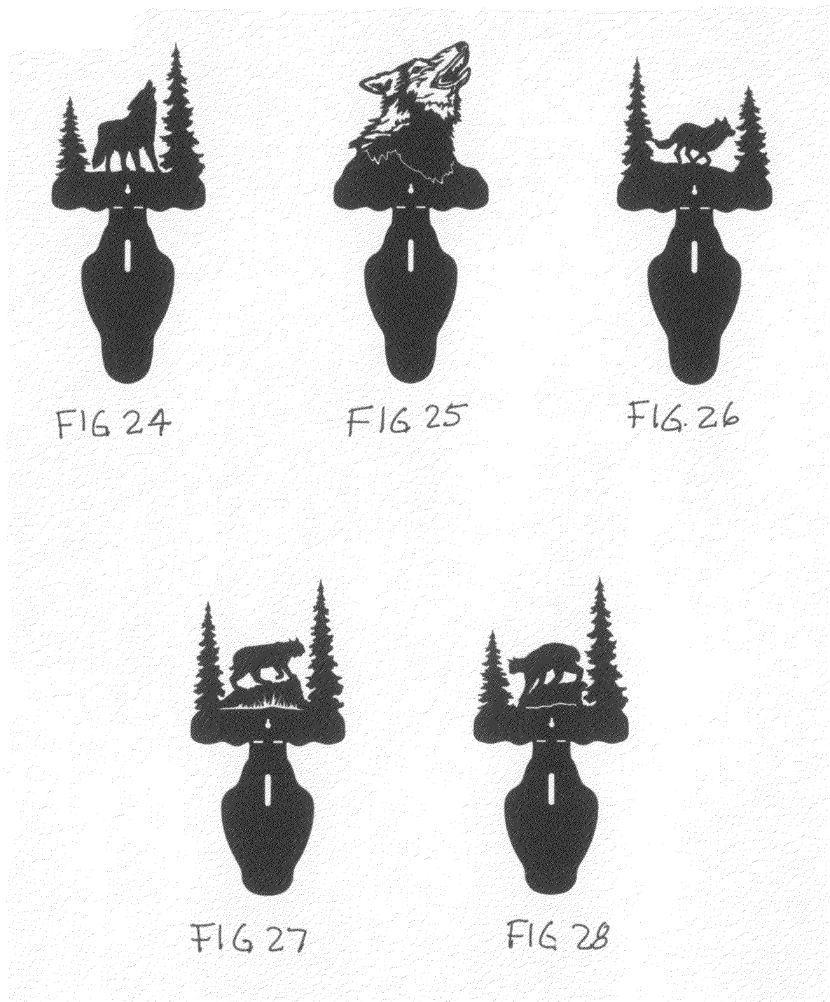

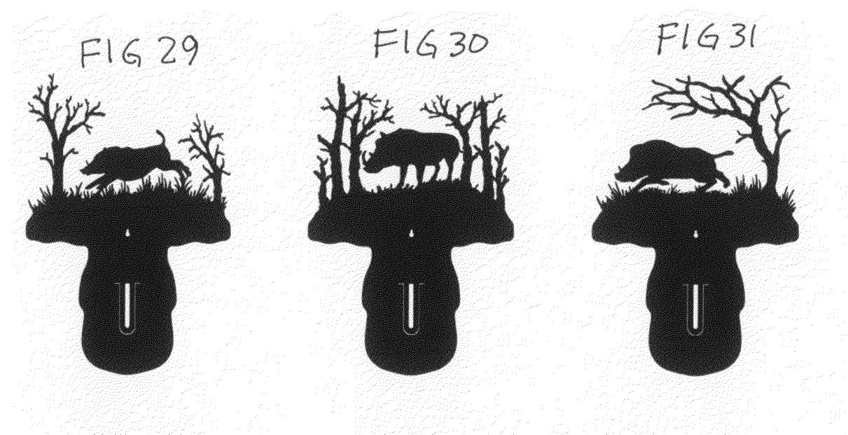

As set forth in the Brief Description of the Figures, FIGS. 6 and7 show some possible variations of a display apparatus 10 for use with an antelope skull. FIGS. 9 and 10 similarly provide a few possible variations of a display apparatus 10 for use with a cougar skull. FIGS. 11 and 12 show possible variations of a display apparatus 10 for use with ram skulls. Likewise, FIGS. 13 through 17 provide a number of possible variations of a display apparatus 10 for use with a bear skull. FIGS. 18 through 23 show a number of possible variations of a display apparatus 10 for use with a deer skulls. FIGS. 24 through 26 show a few variations of a display apparatus 10 for use with wolf skulls. FIGS. 27 and 28 show a few variations of a display apparatus 10 for use with a bobcat skull. Finally, FIGS. 29 through 31 show possible variations of a display apparatus 10 for use with a wild boar skull. It will be obvious that a variety of different silhouetted scenes could likewise be created for a variety of other types of animals not specifically mentioned herein.

It is envisioned that different sizes could be provided for each animal skull type. For example, a large size might be utilized to accommodate a particularly large skull or for use on a wall which has significant available space for a larger display. Conversely, a small size might be utilized for an animal skull which is smaller or for a wall which does not have significant space available. For each animal skull type, it is preferred to adjust the width of the neck portion, body portion and nose portion of the base plate to provide a border around the skull of that particular type of animal. Further, for each animal type, a variety of different silhouetted scenes may be created to allow the hunter or sportsmen to select a particular scene which is most aesthetically pleasing. Because the display apparatus of the present invention can be formed from a single sheet of metal, it is relatively easy to manufacture, has a low manufacturing cost, is light weight and is easily nested for compact shipment. Further, a virtually endless number of different silhouetted scenes could be created for each animal type allowing a collector to display multiple skulls of the same animal type each in a unique an aesthetically pleasing manner. While the present invention is specifically designed for use with animal skulls, the invention could likewise be used for animal heads (which include skull) which have been prepared by a taxidermist for display.

It is to be understood that while certain forms of the present invention have been illustrated and described herein, the present invention is not to be limited to the specific forms or arrangements of parts described and shown.

I claim:

1. A display apparatus for an animal skull comprising:
a) a base plate sized to receive the skull of an animal, said base plate having a neck portion, a body portion and a nose portion; and
b) a wall display plate, said wall display plate being attached to said base plate at a bend having a mounting angle B of between 120° and 150°, said wall display plate adapted to be mounted to and to lie flat against a vertical wall whereby when said wall display plate is mounted to a vertical wall said base plate slopes downwardly with said nose portion being at a lowest location and said neck portion being at a highest location on said base plate, said wall display plate displaying a silhouetted scene including an animal of a same type as the animal skull to be mounted on said display apparatus.

2. A display apparatus according to claim 1 wherein said body portion has at least one vertical cut out slot therein to receive a skull mounting bolt at any location along the vertical slot to allow for vertical adjustment of the skull on the base plate.

3. A display apparatus according to claim 1 wherein a plurality of slots are cut into said sheet of metal at the location of said bend.

4. A display apparatus according to claim 1 wherein said mounting angle is between 130° and 140°.

5. A display apparatus according to claim 1 wherein said mounting angle is approximately 135°.

6. A display apparatus according to claim 1 wherein said base plate and said wall display plate are made from a single sheet of metal with a bend at said mounting angle.

7. A display apparatus according to claim 6 wherein said metal has a thickness in range of approximately 1/32 inch to ⅛ inch.

8. A display apparatus according to claim 1 wherein said base plate and said wall display plate are completely black in color.

9. A display apparatus according to claim 1 wherein said neck portion has a narrow neck width and being attached to said wall display plate, said body portion has a wide body width and said nose portion has a narrow nose width.

10. A display apparatus according to claim 9 wherein when said neck width is added to said nose width, a total neck-plus-nose width is approximately equal to said body width.

11. A display apparatus according to claim 9 wherein said animal skull is a coyote skull and said neck width is less than said nose width.

12. A display apparatus according to claim 9 wherein said animal skull is a bear skull and said neck width is greater than said nose width.

13. A display apparatus according to claim 9 wherein said animal skull is a deer skull and said neck width is greater than said nose width.

14. A display apparatus according to claim 9 wherein said animal skull is a cat skull and said neck width is greater than said nose width.

15. A display apparatus according to claim 9 wherein said animal skull is a swine skull and said neck width is less than the nose width.
